(19) United States
(12) Patent Application Publication
(10) Pub. No.: US 2020/0166077 A1
(43) Pub. Date: May 28, 2020

(54) PROCESS OF MANUFACTURING SELF-LUBRICATING ELEMENTS WITH NANOMETRIC LUBRICANTS

(71) Applicant: Etienne Henrique Jensen, Araras (BR)

(72) Inventor: Etienne Henrique Jensen, Araras (BR)

(21) Appl. No.: 16/199,342

(22) Filed: Nov. 26, 2018

(51) Int. Cl. F16C 33/28; D06M 11/74; D06M 11/58; D06M 11/51; D06M 15/256; D06M 23/00

(52) U.S. Cl. CPC F16C 33/28; D06M 11/74; D06M 11/58; B82Y 30/00; D06M 15/256; D06M 23/00; D06M 11/51

(57) ABSTRACT

A process for the manufacturing of self-lubricating elements such as bearings, plates, bushings and the like with composites obtained by impregnating special synthetic fabrics with thermosetting resins, catalyst and nano graphite and/or molybdenum disulfide nano and/or nano PTFE and/or nanoboron nitride, each of these, or other nanometric lubricants, added according to the tribological applications and requirements of the product.

### BACKGROUND OF THE INVENTION

### Technical Field

The present application for patent of invention of an unprecedented process of manufacturing self-lubricating elements with nanometric lubricants was developed to meet the tribological needs of systems with solid lubrication, its highlight being the incorporation of lubricants on a nano-scale, in accordance with the specific use of the product and/or self-lubricating element.

### Prior Art

In self-lubricating polymer systems composed of thermosetting resin reinforced by synthetic fabrics and solid lubricants, such as, for example, but not limited to, the shipbuilding industry, automotive industry, agricultural implements, earthworks, machinery tools and others. Self-lubricating elements are understood to be bearings for hydroelectric power stations, agricultural equipment, for presses, for water park rides/entertainment, as well as sliding boards of forklift truck beams, guide rings for hydraulic cylinders, wicket gate dowels, bushings of various types of sluices, etc.

Lately, environmental concerns have become a priority for society in general, the industrial segment being no different.

In the automotive industry, machine elements subject to wear, which were originally manufactured in steel lubricated by grease, began using brass as raw material, thus eliminating not only the dirt from lubricant leaks, but also environmental contamination.

In view of the required loads associated with shocks and high temperatures, the steel industry also preferred the use of brass with inserts of solid lubricants, being no different in the generation of cleaner electricity with the use of bronze alloy-based self-lubricating systems.

The oil industry, having needs similar to those mentioned above, also began to use copper-based self-lubricating elements.

However, copper, brass and their alloys are noble and finite metals, and with the increasing demand generated the need arose to seek alternative solutions such as self-lubricating, high-performance composites.

A self-lubricating composite is a thermosetting polymer matrix, with the additive of solid lubricants reinforced by synthetic fabrics, being composed of bi-component resins of the epoxy, vinyl ester or polyesters types.

In this sense, one of the first composites ever known to be used as bearing consisted of liquid phenolic resins reinforced with cotton fabric. Although these resins are resistant to humidity, the same is not true with cotton which deteriorates upon absorbing water. In a technological evolution, the composites had the addition of graphite, in a first moment, without any tribological research. Other advances came with the introduction of synthetic resins and the replacement of cotton for high-performance synthetic fabrics such as polyester, Nomex® fibers, aramids and Kevlar® fibers, which confers on the products differentiated characteristics compared to their individual properties. As for additives, the most used self-lubricating composites are graphites, molybdenum bisulphides, polytetrafluoroethylene (PTFE), boron nitride, and other metal oxides.

The current state of the art includes some patent documents relating to self-lubricating composites such as U.S. Pat. No. 5,180,761 which describes a process of manufacturing of self-lubricating material prepared from polymers with solid lubricants, creating a composite with reduced friction coefficient, using thermoplastic as process matrix.

Although reducing the friction coefficient, the above solution still uses the lubricants on a micrometric scale, which causes some physico-chemical and mechanical constraints. The most prominent solid lubricants are graphite, polytetrafluoroethylene (PTFE), molybdenum disulfide (MoS₂), boron nitride, WS₂ and talcum, all of which have been known for a long time.

Natural graphite is only found in large lamellas, and the grinding processes are unable to reduce its size below the micrometer scale, the same occurring with the other solid lubricants, which despite more recent processing than the graphite, also failed to surpass said scale.

Accordingly, current products, for the most part, basically use natural over artificial graphite and powder and sintered PTFE. The latter has a thermal anomaly between 20-30° C. in which the expansion coefficient undergoes significant volume increase, limiting its use in bearing projects with this type of lubricant. Similarly, there are limitations when using immersed in seawater due to galvanic corrosion in the presence of the micrometric graphite. Regarding the transmission of heat and electric energy, a major problem of current bearings lies in low thermal transmission coefficient, drastically limiting the specific pressures x peripheral speeds. Since these systems do not have a fluid to conduct heat, all the energy generated by friction is absorbed instead of being replaced with the environment, such that maintaining the same conditions for prolonged periods will destroy the system by heat and damage to the counter-face thereof.

### BRIEF SUMMARY OF THE INVENTION

Thus, an object of the present invention is to provide self-lubricating elements whose mechanical strength, temperature resistance and friction coefficient meet the demands of the most contemporary equipment.

This is a process of manufacturing self-lubricating composites in which the solid lubricants—preferably graphite, PTFE and Al₂O₃—on a nanoscale are dispersed in a thermosetting resin that can be reinforced with high-performance synthetic fabric, such as polyester, aramid fiber or carbon fiber.

The choice of resin+reinforcement+solid lubricants combination, on the nanoscale, as well as the manufacturing process of the self-lubricating element, allows numerous combinations, whereby generating ideal solutions for different tribological conditions and needs.

The invention also covers hybrid systems, in which part of the micrometric solid lubricants is replaced by their nanoscale equivalents.

### The Technical Problem

The limiting factor for use of nanoscale solid lubricants is that for its dispersion and homogenization to the mix, as well as its stability over time, high energy equipment is needed, which ultimately derails the process in technical and commercial terms.

The solution is to use ultrasonic mixers for low viscosity thermosetting resins and Vortex-type mixers for higher viscosity resins.

### Advantages of the Invention

The market standard for minimum characteristics for self-lubricating polymeric systems composed of thermosetting resins reinforced by synthetic fabrics and solid lubricants, as well as resistance to chemicals, acids and weak bases is as follows:
a) Mechanical resistance≥100 MPa;
b) Resistance to water (swelling)≤1%;
c) Resistance to temperature≥100° C.;
d) Friction coefficient≤0.1; and
e) Volumetric density≤1.3 g/cm³.

According to tests, the following was achieved by adding solid lubricants in the nanoscale:
Increased mechanical resistance—30%;
Reduction of friction coefficient—40%;
Increase of maximum operating temperature—up to 20° C.; and
Increased tensile strength—30-300%.

In short, the present invention features the following significant advantages:
Versatility—the same process provides different products adaptable to various tribological requirements;
Environmentally friendly;
Excellent dimensional stability when the product is subject to fresh water and/or salt water;
High load capacity and resistance to shocks;
High resistance to traction;
High resistance to wear; and
Long useful life.

### BRIEF DESCRIPTION OF THE DRAWINGS

The invention will now be described in detail, based on the illustrations set out in the accompanying drawings:

FIG. 1 is a flow chart of the process of manufacturing self-lubricating elements with nanometric lubricants; and

FIG. 2 is a schematic view of the process of manufacturing self-lubricating elements with nanometric lubricants.

### DETAILED DESCRIPTION OF PREFERRED EMBODIMENTS

The instant process of manufacturing self-lubricating elements with nanometric lubricants, the object of this application for patent of invention, refers to the manufacturing of self-lubricating elements such as bearings, plates, bushings and the like with composites obtained from the impregnation of synthetic fabrics with special thermosetting resins, catalyst and nano graphite and/or molybdenum disulfide and/or nano PTFE and/or nanoboron nitride, each of these, or other nanometric lubricants added in accordance with the applications and tribological needs of the product.

More particularly, the composites used in the manufacturing process of the self-lubricating elements are obtained by impregnating fabrics in polyester thermosetting resins of polyester (65% to 83%) or thermosetting resins in epoxy (70% to 91%) and solid lubricants such as nano graphite (15% to 19%) and/or nano boron nitride (up 4.5%) and/or PTFE (10%) and/or even MoS₂ (5% to 7%) in which limits are adjusted according to the tribological needs for that self-lubricating system. The above components and their respective percentages can be included in a unitary way, in part or in total for the impregnation of the fabric.

The definition of which component should be used is directly related to the needs required for the end product, such as, for example, the conditions of the environment. In this context, the nano PTFE is indicated for use in environments where there is a galvanic and submerged corrosion. The nano graphite and MoS₂ are recommended for general use, provided that the maximum temperature does not exceed 200° C. In contrast, the combination of PTFE and MoS₂ is ideal for the food and pharmaceutical industry.

In the initial stage of the process for obtaining solid lubricant nanoparticles, ultrasonic mixers are used for thermosetting low viscosity resins and Vortex-type mixers for higher viscosity resins. Thus, the impregnation occurs by bathing the polyester fabric in an immersion tank with the mixture of thermosetting resin and the nanolubricant(s) to be used. In this step, if necessary the fabric can be wrapped with reinforcement material, such as, for example, aramid fiber or carbon fiber, with the aim of increasing resistance to shock and/or pressure of the nanometric self-lubricating composite in the filament winding equipment. This process involves filament winding under different tension conditions over a mandrel or male mold. Accordingly, the mandrel rotates while a car moves horizontally, establishing the desired pattern of the nano composite lubricant, resin and fabric. Since the mandrel is completely covered with the desired material thickness, the same is forwarded to the oven in order to cure the fabric, resin and solid nano lubricant combination, which occurs between 110° C. and 250° C. The mandrel can then be removed. In this process, it is possible to define different dimensions for the initial internal and external diameters and for the length, the latter defined by the length measurement of the mandrel and the maximum length of the filament winding equipment. After the above steps, the resulting product is cut to the desired length and machined in accordance with the internal and external diameter requirements for that end product represented by a bushing or bearing.

A manufacturing variation is intended for obtaining the self-lubricating element in the form of a plate whose process is similar to that of the bearing and bushing in which the fabric is rolled. However, in this variation the polyester fabric is impregnated with orthophtalic resin and the pertinent nanolubricants, it being equally possible to add carbon fiber and aramid fiber for reinforcement.

After impregnation, the fabric is pressed with vacuum for the perfect penetration of resin and nano lubricants, and withdrawal of the surplus. After pressing, the material is taken to the oven set to attain the resin curing temperature between 110° C. and 250° C. The composition for impregnation and respective quantities are the same as for those presented for manufacturing the composite in tube form.

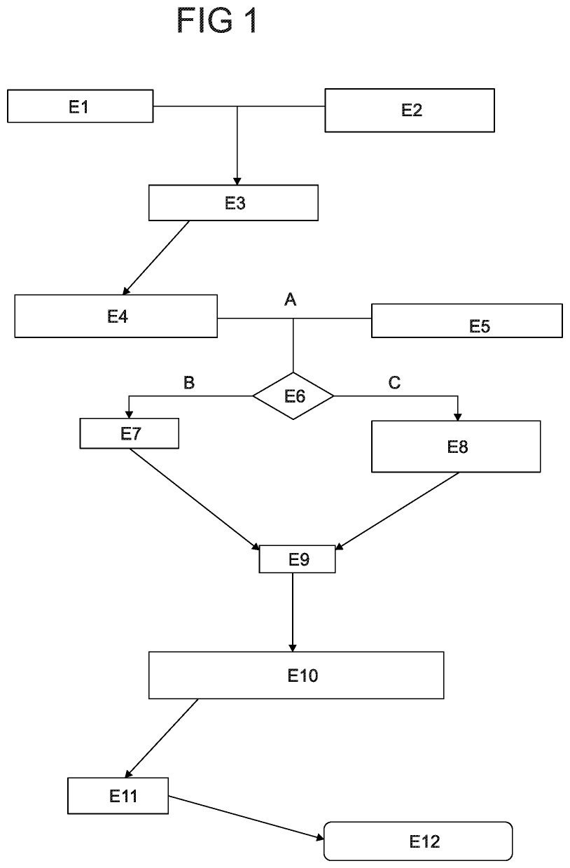

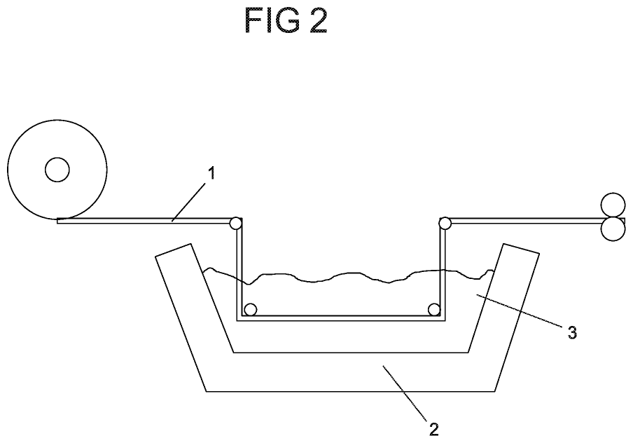

As shown in FIGS. 1 and 2, the resin E1 and the nanoscale lubricants E2, duly dosed, are directed to a mixer E3 where they are homogenized. The mixer varies according to the resin. In the case of high viscosity thermosetting resins it is of the Vortex type and thermosetting resins of low viscosity of the ultrasonic type. The mixed and homogenized resin and the lubricant E4 are ready to impregnate A polyester fabric E5. Such impregnation occurs with passage of the fabric 1 in an immersion tank 2 containing the mixture 3 in paste form. At this point, the process enters a decision-making stage E6 that defines which type of raw material or self-lubricating final element is desired.

For the production of plates B, when the impregnated fabric leaves the tank, it is directed to a press E7, whereas for the production of dowels C—bushings and bearings—the fabric is wrapped by filament winding equipment E8. In both situations, the products are placed in an oven/stove E9 between 110° C. and 250° C. so that the raw material E10 in plate or dowel attains curing temperature. Thereafter, the process follows on to machining E11 in order to obtain the finished product E12.

In an example of applying the process for producing a bushing for use in grain harvesting equipment, an analysis is made of the dimensions such as inner diameter, outer diameter, length, speed, temperature, friction coefficient and load factor on the bearing and other data necessary for the proper functioning of the self-lubricating element. Thus, the manufacturing process of this bushing uses polyester fabric with appropriate measures to achieve the measurement of the end product.

The impregnation of the fabric is with high viscosity polyester resin (75%), nano PTFE (10%), nano MoS₂ (4%) to complement the solid lubrication and catalyst for the resin (11%), these being homogenized in a Vortex mixer. After impregnation of the fabric, the resin+nanolubricant+fabric combination is wrapped in filament winding equipment, with diameters pre-defined for the end product. The internal diameter of the bushing is given by the outer diameter of the mandrel. After winding, the raw material is placed in an oven to attain curing temperature, in this case 150° C.

After curing and cooling, the bushing is machined to achieve the final design measurements.

What is Claimed is:

1. A process of manufacturing self-lubricating elements with nanometric lubricants comprising using a combination of polyester fabric impregnated with thermosetting resins, added with homogenized nanometric lubricants in mixers, being quantitatively and qualitatively according to the tribological requirements.

2. The process of manufacturing self-lubricating elements with nanometric lubricants according to claim 1, wherein the process comprises using:
polyester fabrics with thermosetting resins selected from the group consisting of 65% to 83% polyester and 70% to 91% epoxy; and
solid lubricants selected from the group consisting of 15% to 19% nanographite, up 4.5% nanoboron nitride, up to 10% PTFE, and 5% to 7% MoS₂.

3. The process of manufacturing self-lubricating elements with nanometric lubricants according to claim 1, wherein the components and respective percentages are included, in a unitary way, in part or in total for the impregnation of the fabric.

4. The process of manufacturing self-lubricating elements with nanometric lubricants according to claim 2, wherein the components and respective percentages are included, in a unitary way, in part or in total for the impregnation of the fabric.

5. The process of manufacturing self-lubricating elements with nanometric lubricants according to claim 1, wherein the process uses Vortex type mixers for higher viscosity resins and ultrasonic mixers for lower viscosity resins.

6. The process of manufacturing self-lubricating elements with nanometric lubricants according to claim 1, wherein the fabric is impregnated in a tank containing the resin mixture plus the nanometric lubricants.

7. The process of manufacturing self-lubricating elements with nanometric lubricants according to claim 1, further comprising wrapping the fabric with reinforcement material selected from the group consisting of aramid fiber and carbon fiber.

8. The process of manufacturing self-lubricating elements with nanometric lubricants according to claim 6, further comprising wrapping the fabric with reinforcement material selected from the group consisting of aramid fiber and carbon fiber.

9. The process of manufacturing self-lubricating elements with nanometric lubricants according to claim 1, wherein the material follows on to a press for production of plates or to filament winding equipment for production of dowels.

10. The process of manufacturing self-lubricating elements with nanometric lubricants according to claim 6, wherein the material follows on to a press for production of plates or to filament winding equipment for production of dowels.

11. The process of manufacturing self-lubricating elements with nanometric lubricants according to claim 1, wherein the material follows on to an oven at a temperature of between 110° C.-250° C.

12. The process of manufacturing self-lubricating elements with nanometric lubricants according to claim 6, wherein the material follows on to an oven at a temperature of between 110° C.-250° C.

13. The process of manufacturing self-lubricating elements with nanometric lubricants according to claim 1, wherein the material, in plate or dowel form, is subject to machining to provide an end product.

14. The process of manufacturing self-lubricating elements with nanometric lubricants according to claim 6, wherein the material, in plate or dowel form, is subject to machining to provide an end product.
